(19) United States
(12) Patent Application Publication
(10) Pub. No.: US 2017/0054900 A1
(43) Pub. Date: Feb. 23, 2017

(54) MONITORING SYSTEM AND WEARABLE DEVICE WITH SAME

(71) Applicant: Chiun Mai Communication Systems, Inc., New Taipei (TW)

(72) Inventors: HOW-WEN CHIEN, New Taipei (TW); CHUANG-WEI CHUEH, New Taipei (TW); KAI-CHUN CHANG, New Taipei (TW)

(21) Appl. No.: 15/238,690

(22) Filed: Aug. 16, 2016

(30) Foreign Application Priority Data
Aug. 19, 2015 (CN) 201510509126.6

(51) Int. Cl. H04N 5/232; G01P 13/00; H04N 5/225; G01K 13/04; G06K 9/00; H04N 5/33

(52) U.S. Cl. CPC H04N 5/23222; H04N 5/23212; H04N 5/23241; G06K 9/00281; G06K 9/00597; H04N 5/332; H04N 5/2257; G01K 13/04; G01P 13/00

(57) ABSTRACT

A monitoring system includes a detecting module, a controlling module, a warning module, and a camera module. The detecting module is configured to detect physical parameters of an object in a detecting area and generate a detecting signal. The controlling module is configured to compare the physical parameters with preset reference parameters, and generate a starting signal according to a comparing result. The warning module is configured to generate a warning in response to the starting signal. The camera module is configured to capture an image of the detected object in response to the starting signal.

### CROSS-REFERENCE TO RELATED APPLICATIONS

This application claims priority to Chinese Patent Application No. 201510509126.6 filed on Aug. 19, 2015, the contents of which are incorporated by reference herein.

### FIELD

The subject matter herein generally relates to a monitoring system and a wearable device with same.

### BACKGROUND

People's safety and awareness is gradually raised, however, social cases are still happened. Most of victims are usually attacked from behind and criminals generally tend to choose a place where there is no camera installed, which is difficult to protect the victims and makes the police to have great difficulty in solving crimes.

### BRIEF DESCRIPTION OF THE DRAWINGS

Implementations of the present technology will now be described, by way of example only, with reference to the attached figures.

FIG. 1 is a block diagram of an exemplary embodiment of a monitoring system.

FIG. 2 is an elevated view of a first embodiment of a wearable device.

FIG. 3 is similar to FIG. 2, but shown in another angle.

FIG. 4 is a partial exploded view of the wearable device of FIG. 2.

FIG. 5 is a cross-sectional view of FIG. 2 taken along line V-V.

FIG. 6 is an elevated view of a second embodiment of a wearable device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a monitoring system and a wearable device with same.

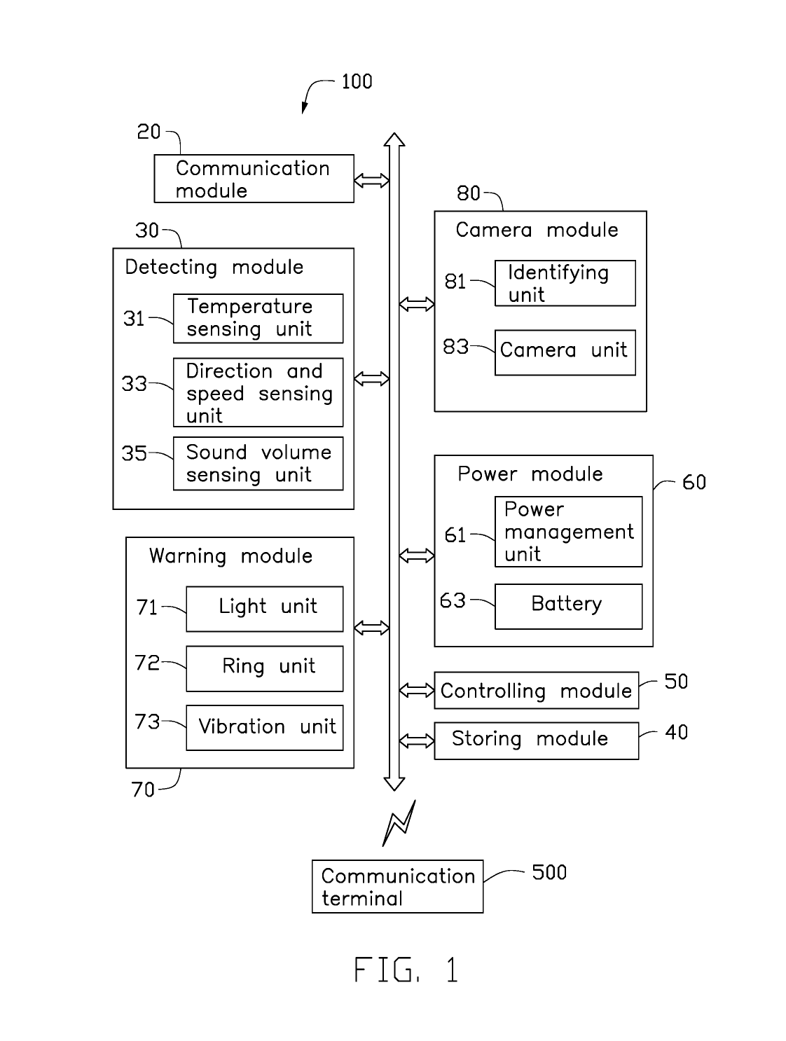

FIG. 1 illustrates a monitoring system 100, which can be applied to a wearable device. The monitoring system 100 is configured to monitor dangerous factors in a detecting area and provide a response in response to the dangerous factors, for example, the monitoring system 100 can assist a user of the wearable device to monitor the dangerous factors beyond the user's line of sight, remind the user timely, and/or shoot images, thereby improving the user's personal security.

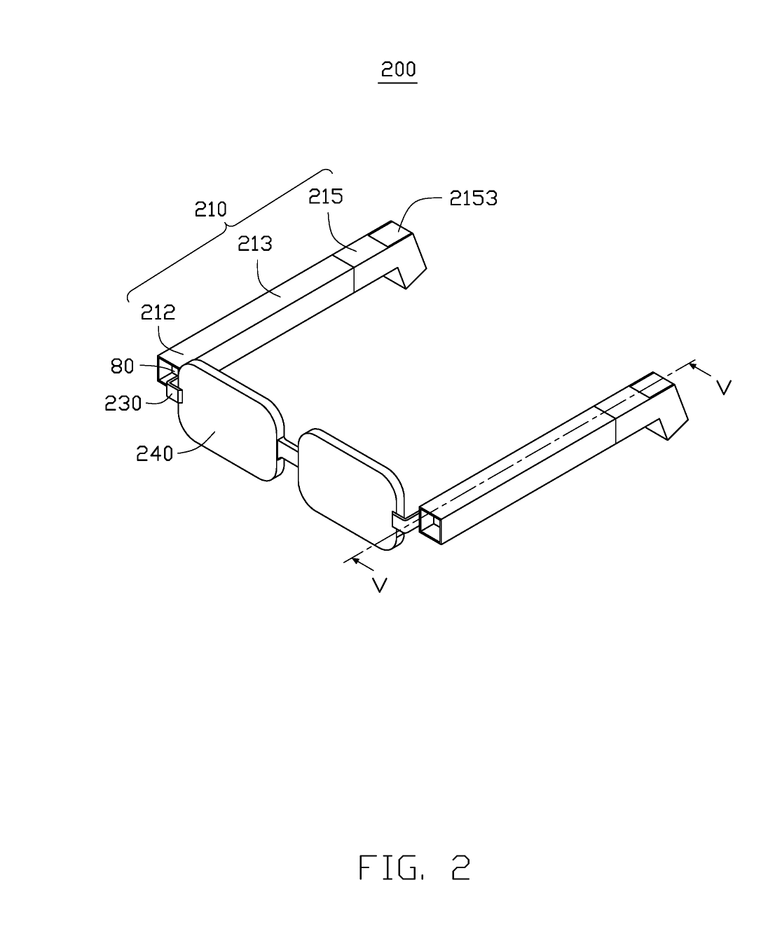

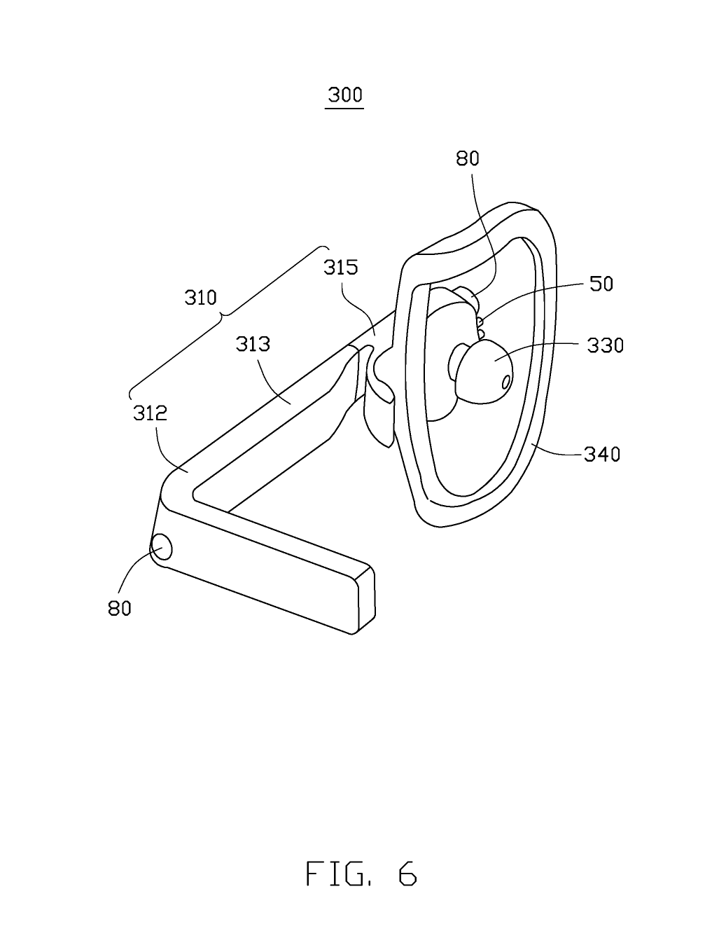

The wearable device can be a pair of glasses (shown in FIG. 2), a Bluetooth earphone (shown in FIG. 6), a hat, earrings, a hairpin, or the like. The wearable device is in communication with a communication terminal 500 to realize data interaction and the user can control the wearable device through the communication terminal 500. In at least one exemplary embodiment, the communication terminal 500 can be an electronic device or a terminal server. The electronic device can be a mobile phone, and/or a tablet.

The monitoring system 100 includes a communication module 20, a detecting module 30, a storing module 40, a controlling module 50, a power module 60, a warning module 70, and a camera module 80. The communication module 20, the detecting module 30, the storing module 40, the controlling module 50, the power module 60, the warning module 70, and the camera module 80 are all positioned in the wearable device.

The communication module 20 is configured to set up a communication channel with the communication terminal 500, thereby realizing data interaction between the monitoring system 100 and the communication terminal 500. The communication module 20 can set up the communication channel with the communication terminal 500 through any one of communication protocols, such as, Bluetooth, NFC, WIFI, 2G, 3G, and 4G.

The detecting module 30 is configured to detect physical parameters of an object in a detecting area and send the physical parameters of the detected object to the controlling module 50. The physical parameters at least include a temperature of the detected object, a moving direction and a moving speed of the detected object, and a sound volume of the detected object. In detail, the detecting module 30 includes at least one group of sensing units for detecting the physical parameters. The at least one group of sensing units includes at least one of a temperature sensing unit 31, a direction and speed sensing unit 33, and a sound volume sensing unit 35.

The temperature sensing unit 31 is configured to sense a temperature of the detected object, for example, a person, a flame, and other heat sources, and generate a temperature signal. The temperature sensing unit 31 can be an infrared sensor, an infrared camera, or an infrared video camera. The direction and speed sensing unit 33 is configured to sense a moving direction and a moving speed of the detected object, for example, a person or a vehicle, and generate a moving direction signal and a moving speed signal. In detail, the direction and speed sensing unit 33 can include a plurality of infrared transmitters and receivers (not shown). The plurality of infrared transmitters and receivers can be arranged according to a certain manner, for example, arranged in parallel. The infrared transmitters transmit infrared rays to the detected object. Then, a moving direction and a moving speed of the detected object can be detected by analyzing a time difference and a direction from the infrared transmitters, which transmits infrared rays to the detected object, to the infrared receivers that receives the infrared rays. The sound volume sensing unit 35 is configured to sense sound volume in decibels from the detected object, for example, a person, and generate a volume signal.

The storing module 40 is configured to store reference parameters, camera data from the camera module 80, and system program data, for example, a preset electrical power value of a battery 63. The reference parameters include at least a reference temperature, a reference direction and speed, and a reference sound volume. In detail, the reference temperature can be a person's temperature range. The reference direction can be a moving direction that the detected object is moving towards the user. The reference speed can be a person's normal walking speed range. The reference sound volume can be a volume range when that person walks or speaks in a normal state.

The controlling module 50 is configured to provide a response in response to a controlling signal, thereby controlling the communicating module 20, the detecting module 30, the storing module 40, the power module 60, the warning module 70, and the camera module 80 to execute corresponding instructions. The controlling signal can be generated when the controlling module 50 executes a preset program, or generated when the user operates the wearable device. The controlling signal can also come from the communication terminal 500, such that the user can control the monitoring system 100 through the communication terminal 500. The controlling signal can be used to control the monitoring system 100 to turn on or turn off, the camera module 80 to start up or shut down, a working mode of the camera module 80, a modification of the reference parameters, a selection of warning manner of the warning module 70, and even download, delete, and edit of the data stored in the storing module 40.

In detail, the controlling module 50 is configured to receive the physical parameters from the detecting module 30, compare the detected physical parameters with the reference physical parameters to determine whether there is a dangerous factor in the detecting area, and generate a starting signal according to the comparing result to control working states of the warning module 70 and the camera module 80. When the controlling module 50 receives the temperature signal and/or the volume signal from the detecting module 30, the controlling module 50 compares the detected temperature value with a reference temperature, and/or compares the detected volume value with a reference volume. When at least one of the detected physical parameters, that is, the temperature and/or the volume, exceeds the reference parameter, the controlling module 50 determines that there is a dangerous factor in the detecting area.

When the controlling module 50 receives the moving direction signal of the detected object from the detecting module 30, the controlling module 50 compares the detected moving direction of the moving direction signal with a reference moving direction. When the detected moving direction is in the range of the reference moving direction, which indicates that there is a person, flames, or other heat source closing to the user. Then, the controlling module 50 further compares the detected moving speed of the moving speed signal with a reference moving speed. When the detected moving speed exceeds the reference moving speed, the controlling module 50 determines that there is a dangerous factor in the detecting area. When the comparing results indicate that there is a dangerous factor in the detecting area, the controlling module 50 generates the starting signal and sends the starting signal to the warning module 70 and the camera module 80.

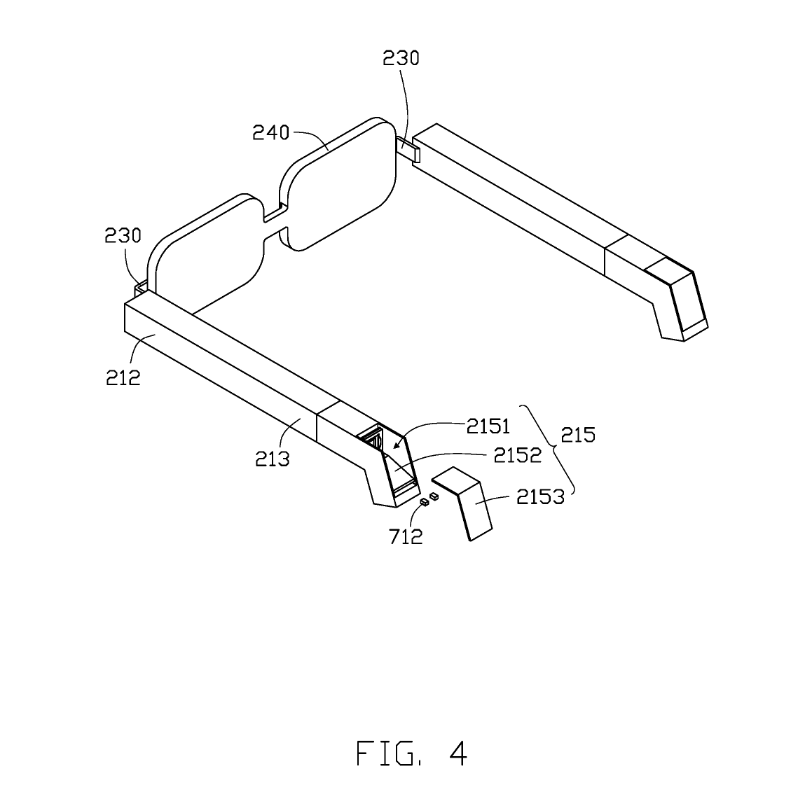

The warning module 70 is configured to provide a response in response to the starting signal to generate warning information. The warning module 70 includes a light unit 71, a ring unit 72, and a vibration unit 73. The light unit 71 includes two LEDs 712 with different colors (shown in FIG. 4). In this exemplary embodiment, one LED 712 is red and the other LED 712 is green. When the monitoring system 100 is in operation and the warning module 70 does not receive the starting signal from the controlling module 50, the green LED 712 is turned on, the red LED 712 is turned off, and the vibration unit 73 is turned off. When the monitoring system 100 is in operation and the warning module 70 receives the starting signal from the controlling module 50, the green LED 712 is turned off and the red LED 712 is turned on to a blinking mode, which indicates that the camera module 80 is in a working state and warns the user about the detected object. In addition, the vibration unit 73 is vibrated to remind the user. When the warning module 70 receives the starting signal, the ring unit 72 makes a sound for warning purposes. The warning module 70 can further provide a response in response to the controlling signal and switch the warning manner, for example, combining the use of light, vibration, and volume according to users' need.

The power module 60 is configured to provide power to the communication module 20, the detecting module 30, the storing module 40, the controlling module 50, the warning module 70, and the camera module 80. The power module 60 includes a power management unit 61 and the battery 63. The power management unit 61 is configured to detect a remaining power level of the battery 61, generate an electrical signal, and send the electrical signal to the controlling module 50. The controlling module 50 compares the remaining power level of the battery 61 with a preset electrical power level. When the remaining power level of the battery 61 is less than the preset electrical power level, the controlling module 50 generates a low electrical signal and sends the low electrical power signal to the camera module 80. Then, the camera module 80 is changed from a working mode to a power-saving mode.

The camera module 80 is configured to provide a response in response to the starting signal. The camera module 80 includes an identifying unit 81 and a camera unit 83. The identifying unit 81 is configured to determine a distance of the detected object, generate a location signal, and send the location signal to the camera unit 83. When the detected object is a person, the identifying unit 81 determines a distance of the detected object by identifying a facial feature and silhouette, for example, eyes, nose, and/or mouth, and generates the location signal. In at least one exemplary embodiment, the identifying unit 81 identifies the detected object through the image (photo or video) taken by the camera unit 83.

Furthermore, the identifying unit 81 includes an eye sensor (not shown) and an infrared transmitter (not shown). When the eye sensor identifies a person's eyes in the detecting area, the infrared transmitter emits infrared rays to a location where the person's eyes are positioned. Then, the identifying unit 81 generates the location signal according to a time difference between when the infrared transmitter transmits the infrared rays and when the infrared rays is received, to indicate a distance between the detected object in the detecting area and the camera module 80, that is, a distance between the detected person and the user of the monitoring system 100.

The camera unit 83 is configured to adjust optical focus to focus on the detected object to obtain one or more clear images (photos and/or videos) of the detected object in response to the starting signal and the location signal.

In detail, when the camera module 80 receives the starting signal from the controlling module 50, the identifying unit 81 starts to detect a location of the detected object and sends the location signal to the camera unit 83. The camera unit 83 makes a response to the location signal to adjust optical focus and makes a response to the starting signal to capture one or more images (photos and/or videos) of the detected object. The captured data of the camera unit 83 includes a photo data, a video data, and an audio data. It can be understood that the camera unit 83 further makes a response to the controlling signal to send the captured data to the storing module 40 for storing the captured data, or send the captured data to the communication module 20, then, the captured data can be transmitted to the communication terminal 500 through the communication module 20.

It can be understood that a working mode of the camera unit 83 includes a video mode and a photograph mode. The video mode includes capturing video to generate video data and recording to generate audio data. The photography mode is simply capturing photos to generate photo data. When the camera module 80 is in the power-saving mode, the camera module 80 is in the photography mode.

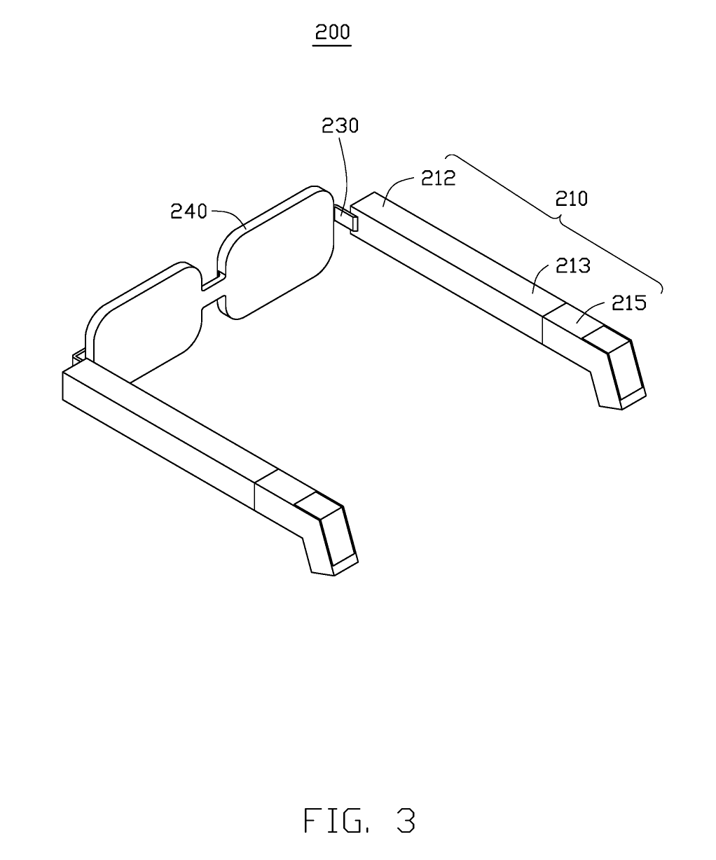

As illustrated in FIG. 2 and FIG. 3, in a first exemplary embodiment, the wearable device 200 is a pair of glasses. The wearable device 200 includes the monitoring system 100, two main portions 210, a connecting portion 230, and two lens 240. The monitoring system 100 is in the two main portions 210.

In this exemplary embodiment, the two main portions 210 are two legs of the pair of glasses that allow a user to wear the wearable device 200 on the head. The two lens 240 are fixed between the connecting portions 230. Each main portion 210 includes a first end portion 212, a second end portion 213, and a bended portion 215. The first end portion 212 is connected to the connecting portion 230. One end of the second end portion 213 is connected to the first end portion 212 and another end of the second end portion 213 is connected to the bended portion 215. The bended portion 215 is positioned at a terminal end of the main portion 210 and is configured to clamp to user's ears and allow the user to wear the wearable device 200 firmly.

In this exemplary embodiment, there are four camera modules 80, which are respectively positioned at two first end portions 212 and two second end portions 213. When the user wears the wearable device 200, two camera modules 80 positioned in the two first end portion 212 are positioned to face a direction of the user's line of sight. Two camera modules 80 positioned in the second end portions 213 are positioned to face a direction outside the range of the user's line of sight.

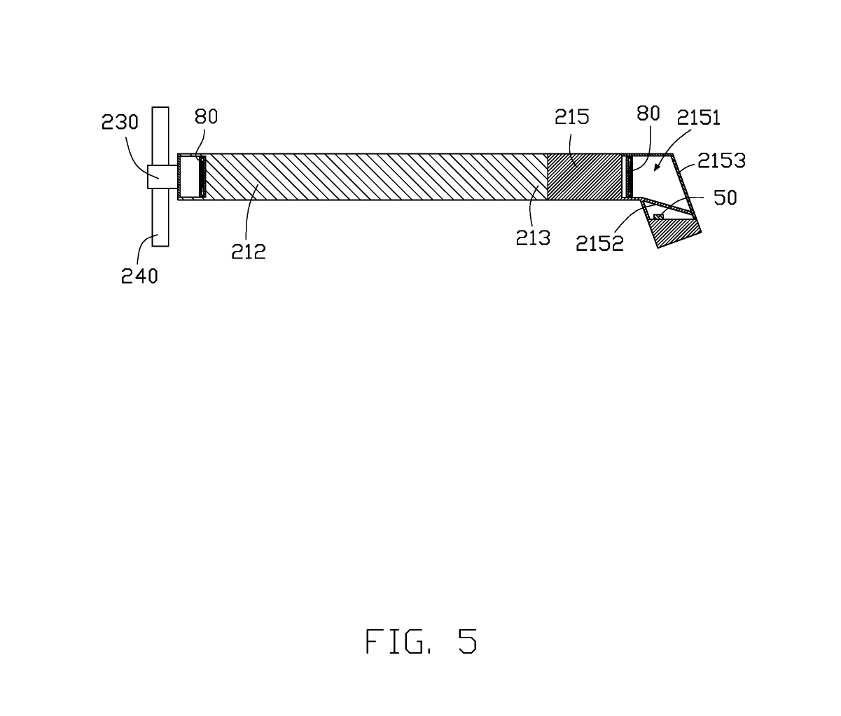

As illustrated in FIG. 4 and FIG. 5, each bended portion 215 defines a receiving slot 2151 at a bended part of the bended portion 215. The receiving slot 2151 is configured to receive the communication module 20, the detecting module 30, the storing module 40, the controlling module 50, the at least one camera module 80, and the light unit 71. In other exemplary embodiments, the communication module 20, the storing module 40, and the controlling module 50 can positioned at other locations of the main portion 210 according to a shape and a structure of the main portion 210. The bended portion 215 includes a light blocking plate 2152 and a protecting shell 2153. The light blocking plate 2152 is in the receiving slot 2151 and isolates the light unit 71 and the camera module 80, thereby preventing the light from the light unit 71 for affecting the camera module 80. The protecting shell 2153 covers the receiving slot 2151 to protect the light unit 71 and the camera module 80. In this exemplary embodiment, the protecting shell 2153 is made of plastic, glass, resin, or other transparent material.

As illustrated in FIG. 1 and FIG. 6, in a second exemplary embodiment, the wearable device 300 is a Bluetooth earphone. The wearable device 300 includes the monitoring system 100, a main portion 310, an earphone device 330, and a mounting portion 340.

The wearable device 300 differs from the wearable device 200 in that the main portion 310 includes a first arm portion 312, a second arm portion 313, and a bended portion 315. The second arm portion 313 connects the first arm portion 312 and the bended portion 315. In this exemplary embodiment, there are two camera modules 80. The two camera modules 80 are configured to capture images from two different directions, for example, two directions opposite to each other. In detail, one camera module 80 is in the first arm portion 312. The other camera module 80 is in the bended portion 315. When the user wears the wearable device 300, the camera module 80 in the first arm portion 312 is positioned to face a direction of the user's line of sight. The camera module 80 in the bended portion 315 is positioned to face a direction outside the range of the user's line of sight.

In other exemplary embodiments, a number of the camera modules 80 is not limited to two, but at least one camera module 80 is in the bended portion 315 for monitoring a direction behind the user. The detecting module 30 is in one end of the bended portion 315 away from the first arm portion 312. Then when the user wears the wearable device 300, the detecting module 30 is positioned at a direction outside the range of the user's line of sight.

The earphone device 330 is positioned at one side of the bended portion 315. The earphone device 330 is received in at least one ear of the user and plays music or audio data. The mounting portion 340 is positioned at one side of the bended portion 315 close to the earphone device 330 and is configured to clamp the wearable device 300 to at least one ear of the user. In this exemplary embodiment, the mounting portion 340 has a loop structure, which matches with a shape of the user's ear.

In other exemplary embodiments, the wearable device can be a headphone or an ear-hook styled earphone. A shape of the main portion of the wearable device can be adjusted according to the type of the earphone.

When the wearable device 200 is a pair of glasses, the wearable device 200 is worn on the user's head and the monitoring system 100 is in an operating mode. The communication module 20 is connected to the communication terminal 500 under an operation of the user or automatically syncs with the communication terminal 500. The communication module 20 can store and automatically sync with identifying information of the communication terminal 500, thereby establishing a connection between the communication module 20 and the communication terminal 500 conveniently and quickly.

When the wearable device 200 is worn, a detecting area of the detecting module 30 and a capturing area of the camera module 80 is preferably beyond the user's line of sight, specially, behind the user. When a person is near and behind the user, that is, when that person enters the detecting area, the temperature parameters from the temperature sensing unit 31 are in the range of the reference parameters, which indicates that there is a dangerous factor in the detecting area. Then the controlling module 50 sends the starting signal to activate the warning module 70 and the camera module 80.

In other exemplary embodiment, the range of the reference parameters can be set to detect a high temperature of flames, when there is a high temperature detected in the detecting area, the controlling module 50 sends the starting signal to activate the warning module 70 and the camera module 80.

When there is a person or a vehicle that moves towards the user and a moving speed exceeds a preset moving speed, this means a risk exists that the detected object will impact the user, thus when the detected object enters the detecting area, the direction and speed sensing unit 33 senses whether a moving speed and a moving direction are in the range of the reference parameters, which will then indicates that there is a dangerous factor in the detecting area, and the controlling module 50 sends the starting signal to activate the warning module 70 and the camera module 80.

In other exemplary embodiments, when, for example, a vehicle horns, the sound volume sensing unit 35 senses that the detected volume exceeds the range of the reference parameters, which indicates that there is a vehicle in the surrounding of the user, that is, there is a dangerous factor in the detecting area, the controlling module 50 sends the starting signal to activate the warning module 70 and the camera module 80. The warning module 70 reminds the user and warns the detected object through a preset warning action, for example, the vibration unit 73 generates vibrations, the ring unit 72 rings, and the LED unit 712 blinks. In addition, the camera module 80 starts to track the detected object, for example, captures photos or videos, and sends the captured data to the storing module 40 and the communication terminal 500 through the communication module 20.

The exemplary embodiments shown and described above are only examples. Many details are often found in the art such as the other features of the electronic device. Therefore, many such details are neither shown nor described.

Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A monitoring system comprising:
a detecting module configured to detect physical parameters of an object in a detecting area and generate a detecting signal;
a controlling module configured to compare the physical parameters with preset reference parameters, and generate a starting signal according to a comparing result;
a warning module configured to generate a warning signal in response to the starting signal; and
a camera module configured to capture an image of the detected object in response to the starting signal.

2. The monitoring system of claim 1, wherein the detecting module comprises at least one of a temperature sensing unit, a direction and speed sensing unit, and a sound volume sensing unit; wherein the temperature sensing unit is configured to sense a temperature of the detected object and generate a temperature signal of the detecting signal; wherein the direction and speed sensing unit is configured to sense a moving direction and a moving speed of the detected object and generate a moving direction signal and a moving speed signal of the detecting signal; and wherein the sound volume sensing unit is configured to sense sound volume from the detected object and generate a volume signal of the detecting signal.

3. The monitoring system of claim 2, wherein when the controlling module receives the temperature signal, the controlling module compares a detected temperature of the temperature signal with a reference temperature, when the detected temperature exceeds the reference temperature, the controlling module determines existence of a dangerous factor in the detecting area and generates the starting signal.

4. The monitoring system of claim 2, wherein when the controlling module receives the volume signal, the controlling module compares a detected volume of the volume signal with a reference volume, when the detected volume exceeds the reference volume, the controlling module determines existence of a dangerous factor in the detecting area and generates the starting signal.

5. The monitoring system of claim 2, wherein when the controlling module receives the moving direction signal, the controlling module compares a detected moving direction of the moving direction signal with a reference moving direction, when the detected moving direction is in a range of the reference moving direction, the controlling further compares a detected moving speed of the moving speed signal with a reference moving speed, when the detected moving speed exceeds the reference moving speed, the controlling module determines existence of a dangerous factor in the detecting area and generates the starting signal.

6. The monitoring system of claim 1, wherein the warning module comprises at least one of a light unit, a vibration unit, and a ring unit; wherein the light unit is configured to generate a light for warning in response to the starting signal; wherein the vibration unit is configured to generate a vibration for warning in response to the starting signal;
and wherein the ring unit is configured to make a sound for warning in response to the starting signal.

7. The monitoring system of claim 1, wherein the camera module comprises an identifying unit and a camera unit; wherein the identifying unit is configured to determine a distance of the detected object and generate a location signal; the camera unit is configured to adjust optical focus on the detected object and capture the image of the detected object in response to the starting signal and the location signal.

8. The monitoring system of claim 1, further comprising a power module, wherein the power module is configured to provide power to the detecting module, the controlling module, the warning module, and the camera module; wherein the power module comprises a power management unit and a battery, the power management unit is configured to detect a remaining power level of the battery, generate an electrical power signal, and send the electrical power signal to the controlling module, the controlling module compares the remaining power level of the battery with a preset electrical power level, when the remaining power level of the battery is less than the preset electrical power level, the controlling module generates a low electrical power signal and sends the low electrical power signal to the camera module to change a working mode of the camera module.

9. A wearable device comprising:
at least one main portion configured to be worn by a user; and
a monitoring system in the at least one main portion and comprising:
a detecting module configured to detect physical parameters of an object in a detecting area and generate a detecting signal;
a controlling module configured to compare the physical parameters with preset reference parameters, and generate a starting signal according to a comparing result;
a warning module configured to generate a warning signal in response to the starting signal; and
a camera module configured to capture an image of the detected object in response to the starting signal.

10. The wearable device of claim 9, wherein the detecting module comprises at least one of a temperature sensing unit, a direction and speed sensing unit, and a sound volume sensing unit; wherein the temperature sensing unit is configured to sense a temperature of the detected object and generate a temperature signal of the detecting signal; wherein the direction and speed sensing unit is configured to sense a moving direction and a moving speed of the detected object and generate a moving direction signal and a moving speed signal of the detecting signal; and wherein the sound volume sensing unit is configured to sense sound volume from the detected object and generate a volume signal of the detecting signal.

11. The wearable device of claim 10, wherein when the controlling module receives the temperature signal, the controlling module compares a detected temperature of the temperature signal with a reference temperature, when the detected temperature exceeds the reference temperature, the controlling module determines existence of a dangerous factor in the detecting area and generates the starting signal.

12. The wearable device of claim 10, wherein when the controlling module receives the volume signal, the controlling module compares a detected volume of the volume signal with a reference volume, when the detected volume exceeds the reference volume, the controlling module determines existence of a dangerous factor in the detecting area and generates the starting signal.

13. The wearable device of claim 10, wherein when the controlling module receives the moving direction signal, the controlling module compares a detected moving direction of the moving direction signal with a reference moving direction, when the detected moving direction is in a range of the reference moving direction, the controlling further compares a detected moving speed of the moving speed signal with a reference moving speed, when the detected moving speed exceeds the reference moving speed, the controlling module determines existence of a dangerous factor in the detecting area and generates the starting signal.

14. The wearable device of claim 9, wherein the warning module comprises at least one of a light unit, a vibration unit, and a ring unit; wherein the light unit is configured to generate a light for warning in response to the starting signal; wherein the vibration unit is configured to generate a vibration for warning in response to the starting signal;
and wherein the ring unit is configured to make a sound for warning in response to the starting signal.

15. The wearable device of claim 9, wherein the camera module comprises an identifying unit and a camera unit; wherein the identifying unit is configured to determine a distance of the detected object and generate a location signal; the camera unit is configured to adjust optical focus on the detected object and capture the image of the detected object in response to the starting signal and the location signal.

16. The wearable device of claim 9, further comprising a power module, wherein the power module is configured to provide power to the detecting module, the controlling module, the warning module, and the camera module; wherein the power module comprises a power management unit and a battery, the power management unit is configured to detect a remaining power level of the battery, generate an electrical power signal, and send the electrical power signal to the controlling module, the controlling module compares the remaining power level of the battery with a preset electrical power level, when the remaining power level of the battery is less than the preset electrical power level, the controlling module generates a low electrical power signal and sends the low electrical power signal to the camera module to change a working mode of the camera module.

17. The wearable device of claim 9, wherein the camera module is in the at least one main portion, when the wearable device is worn by the user, the camera module is positioned to face a direction outside a range of the user's line of sight.

18. The wearable device of claim 17, wherein the at least one main portion comprises a bended portion at an terminal end of the at least one main portion, the bended portion defines a receiving slot at a bended part of the bended portion for receiving the camera module, the detecting module, the controlling module, and the warning module, the bended portion comprises a light blocking plate and a protecting shell, the light blocking plate is in the receiving slot and isolates the warning module and the camera module, and the protecting shell covers the receiving slot.

19. The wearable device of claim 17, wherein the wearable device is a pair of glasses and comprises two main portions, the two main portions are two legs of the pair of glasses, and the bended portion is configured to clamp to the user's ears.

20. The wearable device of claim 17, wherein the wearable device is an earphone, the wearable device comprises an earphone device and a mounting portion, the earphone device is at one side of the at least one main portion, the mounting portion is configured to clamp the wearable device to at least one ear of the user.
